(19) United States
(12) Patent Application Publication
(10) Pub. No.: US 2014/0050905 A1
(43) Pub. Date: Feb. 20, 2014

(54) NEW DOUBLE-SIDED CONDUCTIVE FILM AND PROCESS FOR MANUFACTURING THE SAME

(71) Applicant: NANCHANG O-FILM TECH CO., LTD., Jiangxi (CN)

(72) Inventors: HUAIQING HAO, JIANGXI (CN); RONGJUN CAI, JIANGXI (CN); ZHEN YU, JIANGXI (CN); JINGBO LV, JIANGXI (CN)

(73) Assignee: NANCHANG O-FILM TECH CO., LTD., Jiangxi (CN)

(21) Appl. No.: 14/058,422

(22) Filed: Oct. 21, 2013

Related U.S. Application Data
(63) Continuation of application No. PCT/CN2012/087085, filed on Dec. 20, 2012.

(30) Foreign Application Priority Data
May 14, 2012 (CN) 201210147043.3

(51) Int. Cl. H01B 5/14

(52) U.S. Cl. CPC H01B 5/14
USPC 428/212; 204/192.29

(57) ABSTRACT

The present invention relates to a double-sided conductive film having a relatively high transmittance, which can be widely applied in the field of manufacturing flat panel displays. The flexible transparent film is polyethylene terephthalate, the flexible transparent film is a flexible material having an index of refraction of 1.4 to 1.5; the hardened layer is a surface hardening treatment layer of the flexible transparent film, and is made by coating the upper and the lower surfaces of the flexible transparent film; the adhesive layer is sputtered on a surface of the hardened layer by magnetron sputtering, the main purpose of forming the adhesive is to make the hardened layer and the high refractive index dielectric layer bonded together more firmly; the high refractive index dielectric layer is made of a high refractive index material having a refractive index of 1.8 to 2.5; the low refractive index dielectric layer is made of a low refractive index material having a refractive index of 1.4 to 1.8.

### CROSS-REFERENCE TO RELATED APPLICATIONS

This application is a continuation of International Application No. PCT/CN2012/087085, filed on Dec. 20, 2012, which claims the priority benefit of China Patent Application No. 201210147043.3, filed on May 14, 2012, both of which are hereby incorporated by reference in their entireties.

### TECHNICAL FIELD

The present invention relates to a double-sided conductive film having a relatively high transmittance, which can be widely applied to the field of manufacturing flat panel displays.

### BACKGROUND

Recently, the flat display technology has been developed rapidly, especially, the press button of the mobile touch screen, tablet touch screen and other electronic devices is changed from traditional mechanical buttons to touch buttons, and its market demand shows an upward trend. Indium tin oxide (ITO), as an important raw material in the manufacture of touch screens, remains in a state of shortage.

In the past, the touch screen manufacturing process requires an upper-line and lower-line, i.e. double-sided conductive ITO film. During the unstable process period of an enterprise, the product yield in the printing and laminating is low, while the ITO film is an expensive electronic products, a large number of scrap has reduced the profits of the enterprise, and even caused deficits. Even though some enterprises may have a higher yield, the use of two layers of single side ITO film has compressed the profit margins.

Currently, in order to increase the profit and lower the cost, some enterprises are searching for new materials to replace the ITO film; while other enterprises are searching for new processes to seek a breakthrough without changing the function of the touch screen.

### SUMMARY OF THE INVENTION

In order to overcome the above drawbacks and to meet market demand, one object of the present invention is to provide a process for fabricating a conductive film on two sides of a single layer flexible transparent substrate.

To achieve the above object, the present invention adopts the following technical solution:

A double-sided conductive film comprises a flexible transparent film as a middle layer, a hardened layer, an adhesive layer, a high refractive index dielectric layer, a low refractive index dielectric layer, and an indium tin oxide transparent conductive layer sequentially disposed on an upper surface of the flexible transparent film, and a hardened layer, an adhesive layer, a high refractive index dielectric layer, a low refractive index dielectric layer, and an indium tin oxide transparent conductive layer sequentially disposed on a lower surface of the flexible transparent film.

The flexible transparent film is polyethylene terephthalate, and has an index of refraction of 1.4 to 1.5.

The hardened layer is a surface hardening treatment layer of the flexible transparent film, the hardened layer is made by coating the upper and the lower surfaces of the flexible transparent film.

The adhesive layer is sputtered on a surface of the hardened layer by magnetron sputtering.

The high refractive index dielectric layer is made of a high refractive index material having a refractive index of 1.8 to 2.5.

The low refractive index dielectric layer is made of a low refractive index material having a refractive index of 1.4 to 1.8.

The ITO transparent conductive layer is obtained by bombarding and sputtering indium tin oxide from the target surface to the low refractive index dielectric layer by magnetron sputtering, and In₂O₃ and SnO₂ of the indium tin oxide ceramic target are doped together according to a certain weight ratio, which is between 99/1 to 90/10.

The adhesive layer is made of a material selected from the group consisting of Si₃N₄, SiO, and SiO₂.

The high refractive index material of the high refractive index dielectric layer is preferably Nb₂O₅.

The low refractive index material of the low refractive index dielectric layer is preferably SiO₂.

The weight ratio of In₂O₃ and SnO₂ of the indium tin oxide ceramic target is preferably selected from one of 97/3, 95/5, and 90/10.

A process for fabricating a new double-sided conductive film is disclosed. The film has a structure of: a middle layer of the double-sided conductive film is a flexible transparent film, the film has a hardened layer, an adhesive layer, a high refractive index dielectric layer, a low refractive index dielectric layer, and an indium tin oxide transparent conductive layer sequentially disposed on an upper surface of the flexible transparent film; the film has a hardened layer, an adhesive layer, a high refractive index dielectric layer, a low refractive index dielectric layer, and an indium tin oxide transparent conductive layer sequentially disposed on a lower surface of the flexible transparent film. The process for fabricating the double-sided conductive film is described as follows:

the flexible transparent film is polyethylene terephthalate, the flexible transparent film is a flexible material having an index of refraction of 1.4 to 1.5;

the hardened layer is a surface hardening treatment layer of the flexible transparent film, the hardened layer is made by coating the upper and the lower surfaces of the flexible transparent film;

the adhesive layer is sputtered on a surface of the hardened layer by magnetron sputtering, the main purpose of forming the adhesive is to make the hardened layer and the high refractive index dielectric layer bonded together more firmly;

the high refractive index dielectric layer is made of a high refractive index material having a refractive index of 1.8 to 2.5;

the low refractive index dielectric layer is made of a low refractive index material having a refractive index of 1.4 to 1.8;

the indium tin oxide transparent conductive layer is obtained by bombarding and sputtering indium tin oxide from the target surface to the low refractive index dielectric layer by magnetron sputtering, and In₂O₃ and SnO₂ of the indium tin oxide ceramic target are doped together according to a certain weight ratio, which is between 99/1 to 90/10.

The adhesive layer is made of a material selected from the group consisting of Si₃N₄, SiO, and SiO₂.

The high refractive index material of the high refractive index dielectric layer is preferably Nb₂O₅.

The low refractive index material of the low refractive index dielectric layer is preferably SiO₂.

The weight ratio of In₂O₃ and SnO₂ of the indium tin oxide ceramic target is preferably selected from one of 97/3, 95/5, and 90/10.

The beneficial effects of the present disclosure are:

The product prepared according to the present disclosure has a transmittance in visible light up to 85%, after annealing at 150° C., the square resistance of the two side are between 150 to 30Ω/sq, the square resistance of the two side may both be 150Ω/sq, 200Ω/sq, or 260Ω/sq, etc. For example, one side is 150Ω/sq, the other side is 200Ω/sq. A uniformity of the square resistance is ±20Ω/sq, the color difference ΔR, i.e. a difference in visible reflectance for an ITO layer and without ITO layer, is 0.7%±0.3%, which can meet the market requirement of the ITO film.

### BRIEF DESCRIPTION OF THE DRAWINGS

FIG. 1 is a schematic, cross section view of a double-sided conductive film according to the present invention;

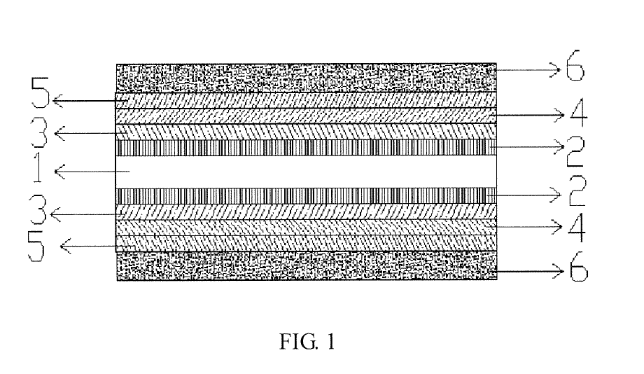

FIG. 2 is a schematic view of a process equipment according to the present invention.

### DETAILED DESCRIPTION

The invention will be described in further detail below in conjunction with the drawing. Illustrative embodiments of the invention are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

A process for fabricating a new double-sided conductive film is disclosed. The film has a structure of: a middle layer of the double-sided conductive film is a flexible transparent film 1, the film has a hardened layer 2, an adhesive layer 3, a high refractive index dielectric layer 4, a low refractive index dielectric layer 5, and an indium tin oxide transparent conductive layer 6 sequentially disposed on an upper surface of the flexible transparent film 1; the film has a hardened layer 2, an adhesive layer 3, a high refractive index dielectric layer 4, a low refractive index dielectric layer 5, and an indium tin oxide transparent conductive layer 6 sequentially disposed on a lower surface of the flexible transparent film 1. The process for fabricating the double-sided conductive film is described as follows:

the flexible transparent film 1 is polyethylene terephthalate, the flexible transparent film 1 is a flexible material having an index of refraction of 1.4 to 1.5;

the hardened layer 2 is a surface hardening treatment layer of the flexible transparent film 1, the hardened layer 2 is made by coating the upper and the lower surfaces of the flexible transparent film 1;

the adhesive layer 3 is sputtered on a surface of the hardened layer 2 by magnetron sputtering, the main purpose of forming the adhesive is to make the hardened layer 2 and the high refractive index dielectric layer 4 bonded together more firmly;

the high refractive index dielectric layer 4 is made of a high refractive index material having a refractive index of 1.8 to 2.5;

the low refractive index dielectric layer 5 is made of a low refractive index material having a refractive index of 1.4 to 1.8;

the indium tin oxide transparent conductive layer 6 is obtained by bombarding and sputtering indium tin oxide from the target surface to the low refractive index dielectric layer 5 by magnetron sputtering, and In₂O₃ and SnO₂ of the indium tin oxide ceramic target are doped together according to a certain weight ratio, which is between 99/1 to 90/10.

The adhesive layer 3 is made of a material selected from the group consisting of Si₃N₄, SiO, and SiO₂.

The high refractive index material of the high refractive index dielectric layer 4 is preferably Nb₂O₅.

The low refractive index material of the low refractive index dielectric layer 5 is preferably SiO₂.

The weight ratio of In₂O₃ and SnO₂ of the indium tin oxide ceramic target is preferably selected from one of 97/3, 95/5, and 90/10.

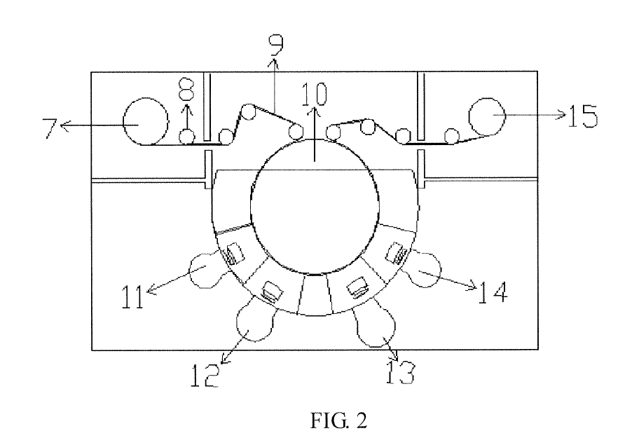

FIG. 2 is a schematic view of a process equipment according to the present invention, which is a schematic view of a magnetron sputtering roll coating equipment. The basic principle is that, when argon is filled in a coating chamber, under the influence of the electromagnetic field, argon ion is generated by glow discharge, argon ion bombards the target surface and sputters out the target particle, which is then reacted with the process gas such as oxygen or nitrogen to generate the desired compound, finally, the compound is deposited on a surface of a substrate. In the present invention, considering the production and a maximum power of the target, the take-speed of the film is set but not limited to 1.4 m/min. The extension of the film is adjusted to be within 500N±200N, based on whether the winding of the winding roller 15 is neat or wrinkling. The target-substrate distance, i.e. the distance between the surface of the target and the surface of the substrate, is fixed to 100 mm according to the process. Before coating, the flexible film 1 is IR heated at a temperature of 300° C. to remove the water vapor contained in the film, then the surface of the film is pretreated, i.e., the surface is bombarded by the plasma generated by argon glow discharge to remove the impurities. The power of the glow discharge is controlled to be 0.5 kw to 2 kw.

Referring to FIG. 2, the unwinding roller 7 is a roller for placing the flexible transparent film 1 with a hardened layer 2. The roller 8 is used to roll the flexible transparent film 1 forwards or backwards. Label 9 refers to the flexible transparent film 1 with a hardened layer 2. The flexible transparent film 1 is firmly attached to a surface of the coating drum 10. Because the power of magnetron sputtering is high and generates a lot of heat, a surface temperature of the coating drum 10 is adjusted to −15° C. to 25° C., which can take away extra heat and prevent label 9 (the flexible transparent film 1 with a hardened layer 2) from being wrinkled due to high temperature. The target 11 is a target for sputtering the adhesive layer 3 with a thickness of 5 nm to 15 nm. When the flexible transparent film 1 with a hardened layer 2 passes by the sputtering target 11, it then passes by the target 12 to sputter the high refractive index dielectric layer 4 with a thickness less than 20 nm. The target 13 is used to sputter the low refractive index dielectric layer 5 with a thickness less than 100 nm. According to the thickness of the low refractive index dielectric layer 5, the number of target is not limited to 1, for example, it can be 1-3. Finally, the target 14 is used to sputter the indium tin oxide transparent conductive layer 6 with a thickness less than 30 nm.

After the coating of one side of the conductive film, the other side is then coated. In order to prevent the roller from damaging the coated ITO during the rolling, the coated ITO is covered by a protective film which is resistant to a high temperature 150° C. During the coating of the other side, according to the demand, the speed and the tension of the film, the power of each target, the content of the gas may be determined as required. The square resistance of the other side is between 150-300Ω/sq, and a uniformity of the square resistance is ±20Ω/sq, the color difference ΔR, i.e., a difference in visible reflectance for an ITO layer and without ITO layer, is 0.7%±0.3%.

What is claimed is:

1. A double-sided conductive film, comprising:
a flexible transparent film as a middle layer;
a hardened layer, an adhesive layer, a high refractive index dielectric layer, a low refractive index dielectric layer, and an indium tin oxide transparent conductive layer sequentially disposed on an upper surface of the flexible transparent film; and
a hardened layer, an adhesive layer, a high refractive index dielectric layer, a low refractive index dielectric layer, and an indium tin oxide transparent conductive layer sequentially disposed on a lower surface of the flexible transparent film.

2. The double-sided conductive film according to claim 1, wherein the flexible transparent film is polyethylene terephthalate, and has an index of refraction of 1.4 to 1.5.

3. The double-sided conductive film according to claim 1, wherein the hardened layer is a surface hardening treatment layer of the flexible transparent film, the hardened layer is made by coating the upper and the lower surfaces of the flexible transparent film.

4. The double-sided conductive film according to claim 1, wherein the adhesive layer is sputtered on a surface of the hardened layer by magnetron sputtering.

5. The double-sided conductive film according to claim 1, wherein the high refractive index dielectric layer is made of a high refractive index material having a refractive index of 1.8 to 2.5.

6. The double-sided conductive film according to claim 1, wherein the low refractive index dielectric layer is made of a low refractive index material having a refractive index of 1.4 to 1.8.

7. The double-sided conductive film according to claim 1, wherein the ITO transparent conductive layer is obtained by bombarding and sputtering indium tin oxide from the target surface to the low refractive index dielectric layer by magnetron sputtering, and In₂O₃ and SnO₂ of the indium tin oxide ceramic target are doped together according to a certain weight ratio, which is between 99/1 to 90/10.

8. The double-sided conductive film according to claim 1, wherein the adhesive layer is made of a material selected from the group consisting of Si₃N₄, SiO, and SiO₂.

9. The double-sided conductive film according to claim 1, wherein the high refractive index material of the high refractive index dielectric layer is Nb₂O₅.

10. The double-sided conductive film according to claim 1, wherein the low refractive index material of the low refractive index dielectric layer is SiO₂.

11. The double-sided conductive film according to claim 1, wherein the weight ratio of IN₂O₃ and SnO₂ of the indium tin oxide ceramic target is selected from one of 97/3, 95/5, and 90/10.

12. A process for fabricating a new double-sided conductive film, the film having a structure of: a middle layer of the double-sided conductive film is a flexible transparent film (1), the film has a hardened layer (2), an adhesive layer (3), a high refractive index dielectric layer (4), a low refractive index dielectric layer (5), and an indium tin oxide transparent conductive layer (6) sequentially disposed on an upper surface of the flexible transparent film (1); the film has a hardened layer (2), an adhesive layer (3), a high refractive index dielectric layer (4), a low refractive index dielectric layer (5), and an indium tin oxide transparent conductive layer (6) sequentially disposed on a lower surface of the flexible transparent film (1);
wherein:
the flexible transparent film (1) is polyethylene terephthalate, the flexible transparent film (1) is a flexible material having an index of refraction of 1.4 to 1.5;
the hardened layer (2) is a surface hardening treatment layer of the flexible transparent film (1), the hardened layer (2) is made by coating the upper and the lower surfaces of the flexible transparent film (1);
the adhesive layer (3) is sputtered on a surface of the hardened layer (2) by magnetron sputtering, the main purpose of forming the adhesive is to make the hardened layer (2) and the high refractive index dielectric layer (4) bonded together more firmly;
the high refractive index dielectric layer (4) is made of a high refractive index material having a refractive index of 1.8 to 2.5;
the low refractive index dielectric layer (5) is made of a low refractive index material having a refractive index of 1.4 to 1.8;
the indium tin oxide transparent conductive layer (6) is obtained by bombarding and sputtering indium tin oxide from the target surface to the low refractive index dielectric layer (5) by magnetron sputtering, and In₂O₃ and SnO₂ of the indium tin oxide ceramic target are doped together according to a certain weight ratio, which is between 99/1 to 90/10.

13. The process according to claim 12, wherein the adhesive layer (3) is made of a material selected from the group consisting of Si₃N₄, SiO, and SiO₂.

14. The process according to claim 12, wherein the high refractive index material of the high refractive index dielectric layer (4) is Nb₂O₅.

15. The process according to claim 12, wherein the low refractive index material of the low refractive index dielectric layer (5) is SiO₂.

16. The process according to claim 12, wherein the weight ratio of In₂O₃ and SnO₂ of the indium tin oxide ceramic target is selected from one of 97/3, 95/5, and 90/10.
